(19) United States
(12) Patent Application Publication
(10) Pub. No.: US 2016/0098726 A1
(43) Pub. Date: Apr. 7, 2016

(54) TELEPHONE TRANSACTION VERIFICATION SYSTEM

(71) Applicant: Mohammad Karaki, Boca Raton, FL (US)

(72) Inventor: Mohammad Karaki, Boca Raton, FL (US)

(21) Appl. No.: 14/508,732

(22) Filed: Oct. 7, 2014

(51) Int. Cl. G06Q 20/40; G06Q 20/28

(52) U.S. Cl. CPC G06Q 20/4097; G06Q 20/28

(57) ABSTRACT

According to one embodiment, a telephone transaction verification system includes one or more processors configured to receive an indication that a card user is attempting to perform a telephone transaction using payment card information. The processors are further configured to transmit a challenge code configured to interrogate a card user identification device for a first verification code, and to receive the first verification code. The first verification code is selected, by the card user identification device, from a plurality of verification codes, and according to a predefined manner. The processors are further configured to select a first comparison code according to the predefined manner, and compare the first comparison code to the first verification code. The processors are further configured to, following a determination that the first comparison code matches the first verification code, transmit a verification signal configured to indicate that the telephone transaction has been verified.

### TECHNICAL FIELD

This disclosure relates generally to the field of transactions and more specifically to a telephone transaction verification system.

### BACKGROUND

When conducting a telephone transaction with a merchant, a customer typically pays for goods or services received from the merchant using credit/debit cards. Payments using credit/debit cards for a telephone transaction typically involve the customer verbally communicating their credit/debit card information to an employee of the merchant during a telephone conversation. Such telephone transactions, however, may be susceptible to fraud. Furthermore, typical techniques for preventing fraud in telephone transactions with credit/debit cards may be deficient.

### SUMMARY

According to one embodiment, a telephone transaction verification system includes one or more memory units and one or more processors. The memory units are configured to store a plurality of comparison codes. The processors are configured to receive an indication that a card user is attempting to perform a telephone transaction using payment card information and a card user telephone device. The card user telephone device is communicatively coupled to a merchant telephone device with which the card user is attempting to perform the telephone transaction. The processors are also configured to, following reception of the indication, transmit a challenge code configured to interrogate a card user identification device for a first verification code. The challenge code is received by the card user telephone device and re-transmitted by the card user telephone device to the card user identification device. The processors are further configured to, following transmittal of the challenge code, receive the first verification code from the card user identification device. The first verification code is selected, by the card user identification device, from a plurality of verification codes stored by the card user identification device, and according to a predefined manner. The first verification code is transmitted by the card user identification device to the card user telephone device and re-transmitted by the card user telephone device to the merchant telephone device. The processors are further configured to select a first comparison code from the plurality of comparison codes according to the predefined manner, and compare the first comparison code to the first verification code from the card user identification device. The processors are further configured to, following a determination that the first comparison code matches the first verification code, transmit a verification signal configured to indicate that the telephone transaction has been verified.

Certain embodiments of the disclosure may provide one or more technical advantages. For example, in order for a telephone transaction to be approved, a verification entity device may compare a comparison code selected by the verification entity device with a verification code selected by a card user identification device. As such, even if a person (or a device) is able to steal or copy a card user's payment card information or the payment card, the person may be unable to conduct one or more telephone transactions using the payment card information (or the payment card) because the person may not also have the card user identification device and/or the verification code stored and selected by the card user identification device. As another example, the card user identification device may select a particular verification code for a telephone transaction by sequentially rotating through each of the verification codes stored by the card user identification device. As such, the same code may be re-used as the verification code at a later date and/or time, and the card user identification device may not need to receive new verification codes from the verification entity device when all of the verification codes have already been used. As a further example, a verification code stored in the card user identification device may be selected and/or communicated for receipt by the verification entity device without intervention by the card user. As such, the verification process may be easier for the card user. As a further example, a merchant verification device may be communicatively coupled to the card user identification device by a merchant telephone device and the card user telephone device. This may allow the telephone transaction to be verified even though it is performed over a telephone connection.

Certain embodiments of the disclosure may include none, some, or all of the above technical advantages. One or more other technical advantages may be readily apparent to one skilled in the art from the figures, descriptions, and claims included herein.

### BRIEF DESCRIPTION OF THE FIGURES

For a more complete understanding of the present disclosure and its features and advantages, reference is now made to the following description, taken in conjunction with the accompanying drawings, in which:

FIG. 1 illustrates an example telephone transaction verification system that verifies telephone transactions between card users and merchants; and

FIG. 2 illustrates an example selection of verification codes and comparison codes of FIG. 1.

### DETAILED DESCRIPTION

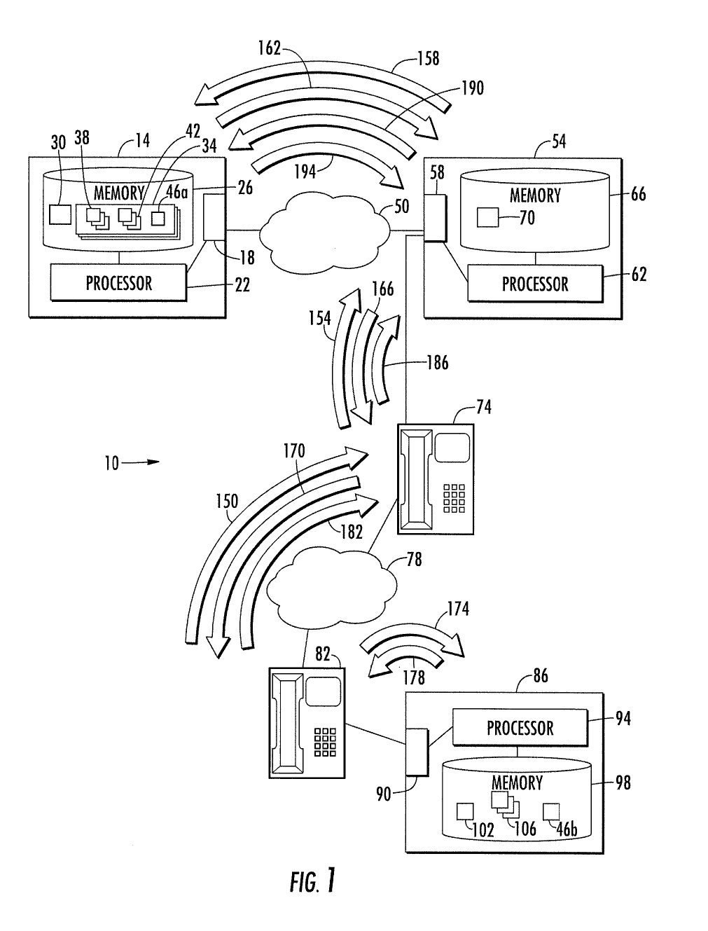

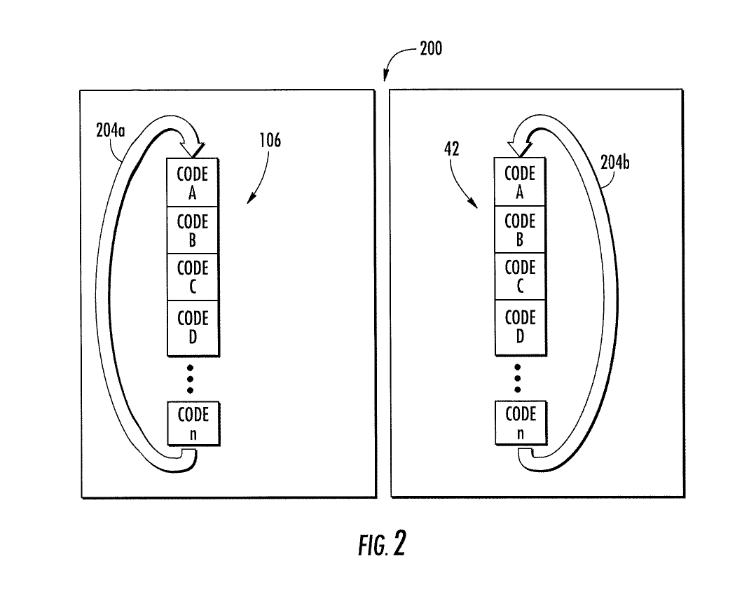

Embodiments of the present disclosure are best understood by referring to FIGS. 1-2 of the drawings, like numerals being used for like and corresponding parts of the various drawings.

FIG. 1 illustrates an example telephone transaction verification system 10 that verifies telephone transactions between card users and merchants. System 10 includes a verification entity device 14 that stores comparison codes 42, and further includes a card user identification device 86 that stores verification codes 106. When a card user attempts to perform a telephone transaction using payment card information (e.g., credit card information) and a card user telephone device (e.g., the card user's mobile phone), the verification entity device 14 may compare a comparison code 42 (which is selected in a predefined manner by the verification entity device 14) with a verification code 106 (which is selected in the same predefined manner by the card user identification device 86 and then communicated to the verification entity device 14) in order to determine whether to approve the telephone transaction. In particular embodiments, this may provide additional protection against fraud. Furthermore, system 10 also includes a merchant verification device 54 that is communicatively coupled to the card user identification device 86 by the merchant telephone device 74 and the card user telephone device 82. In particular embodiments, this may allow the telephone transaction to be verified even though it is performed over a telephone connection, thereby allowing system 10 to provide additional protection against fraud in a telephone transaction.

A verification entity represents an entity that communicates with customers and/or merchants in order to verify telephone transactions between the customers and merchants. For example, a verification entity may be a financial institution, such as a credit card company, credit card servicer, debit card company, debit card servicer, bank, any other institution that communicates with customers and/or merchants in order to facilitate telephone transactions between the customers and merchants, or any combination of the preceding. In such an example, the verification entity verifies telephone transactions for customers that have a credit card account, a savings account, a debit card account, a checking account, any other account associated with the financial institution (or a merchant), or any combination of the preceding. As another example, the verification entity may be a third party entity, such as a clearinghouse, payment processing institution, any other entity that may communicate with a financial institution in order to assist in facilitating telephone transactions between the customers and merchants, or any combination of the preceding. In such an example, the verification entity verifies telephone transactions for customers (and/or merchants) associated with the financial institution. As a further example, a verification entity may be a combination of a financial institution and a third party entity.

A merchant represents an entity in any suitable industry that conducts a transaction (such as a telephone transaction) with a customer. The merchant may include a retailer, a wholesaler, a service company, or any other suitable entity that has customers and conducts transactions with the customers. The merchant may interact with the verification entity associated with a customer in order to facilitate each transaction.

A telephone transaction represents a transaction made between a customer and merchant over a telephone communication network (or any other audio communication network), and may include receiving payment from the customer for goods or services provided by the merchant (or crediting a refund to the customer). An example of a telephone transaction may be a customer calling a merchant over the phone in order to purchase goods from the merchant.

A payment card represents a credit card, a debit card, a check, a coupon linked to an account, a gift card linked to an account, a money order, a promissory note, or any other manner of non-cash payment. A card user (i.e., a customer using the payment card) may use the payment card in order to pay for goods or services from a merchant. For example, for a telephone transaction, the card user may verbally communicate their payment card information to an employee of the merchant in order to pay for goods or services from the merchant. Payment card information may represent any information associated with the payment card, the card user, and/or an account of the card user. For example, payment card information may include the payment card number, the payment card expiration date, the payment card verification code, the billing address associated with the payment card, the card user, and/or the account of the card user, the shipping address associated with the card user, any other information that may be used to process a telephone transaction, or any combination of the preceding.

When conducting a telephone transaction with a merchant, a customer typically pays for goods or services received from the merchant using credit/debit cards. Payments using credit/debit cards for a telephone transaction typically involve the customer verbally communicating their credit/debit card information to an employee of the merchant during a telephone conversation. Such telephone transactions, however, may be susceptible to fraud. Furthermore, typical techniques for preventing fraud in telephone transactions with credit/debit cards may be deficient. As such, in particular embodiments, system 10 of FIG. 1 may verify telephone transactions between card users and merchants in a manner that provide various advantages. For example, in order for a telephone transaction to be approved, the verification entity device 14 may compare a comparison code 42 selected by the verification entity device 14 with a verification code 106 selected by a card user identification device 86 carried by (or otherwise associated with) the card user. In such an example, even if a person (or a device) is able to steal or copy a card user's payment card information or the payment card, the person may be unable to conduct one or more telephone transactions using the payment card information (or the payment card) because the person may not also have the card user identification device 86. Furthermore, even if a person (or a device) is also able to attempt to provide a code to the verification entity device 14 (using a fraudulent device, for example), the provided code may not match the comparison code 42 utilized by the verification entity device 14 because the fraudulent device may not have access to verification codes 106 or a verification management application 46b that results in a verification code 106 being selected in a predefined manner.

As another example, the card user identification device 86 may select a particular verification code 106 for a telephone transaction by sequentially rotating through each of the verification codes 106 stored at the card user identification device 86. In such an example, this may allow the same code to be re-used as the verification code 106 at a later date and/or time from the original use of the code. Furthermore, this may prevent the card user identification device 86 from needing to receive new verification codes 106 from verification entity device 14 (or some other device associated with the verification entity) when all of the verification codes 106 have already been used. As a further example, a verification code 106 stored in the card user identification device 86 may be selected and/or communicated for receipt by the verification entity device 14 without intervention by the card user. In such an example, the verification process may be easier for the card user because the card user may not need to perform any type of action to assist in the verification of the telephone transaction, other than the card user actually carrying the card user identification device 86 with them when performing the telephone transaction (such as carrying the card user identification device 86 in the card user's purse or attached to the card user's keys) and/or other than the card user performing the telephone transaction with a card user identification device 86 that is held (or otherwise positioned) within communication range to the card user telephone device 82 (such as within Bluetooth range, WiFi range, radio frequency identification range, infrared range, sound wave range, or any other suitable range).

As a further example, system 10 also includes a merchant verification device 54 that is communicatively coupled to the card user identification device 86 by the merchant telephone device 74 and the card user telephone device 82. In particular embodiments, this may allow the telephone transaction to be verified even though it is performed over a telephone connection, thereby allowing system 10 to provide additional protection against fraud in a telephone transaction. Therefore, system 10 may verify telephone transactions between card users and merchants in a manner that is advantageous.

Verification entity device 14 represents any suitable components that verify telephone transactions between card users and merchants. Verification entity device 14 may include a network server, any suitable remote server, a mainframe, a host computer, a workstation, a web server, a personal computer, a file server, or any other suitable device for verifying telephone transactions between card users and merchants. The functions of verification entity device 14 may be performed by any suitable combination of one or more servers or other components at one or more locations. In the embodiment where the verification entity device 14 is a server, the server may be a private server, and the server may be a virtual or physical server. The server may include one or more servers at the same or remote locations. Also, verification entity device 14 may include any suitable component that functions as a server. As illustrated, verification entity device 14 includes a network interface 18, a processor 22, and a memory unit 26.

Network interface 18 represents any suitable device operable to receive information from network 50, transmit information through network 50, perform processing of information, communicate to other devices, or any combination of the preceding. For example, network interface 18 receives an indication that the card user is attempting to perform a telephone transaction using payment card information and a card user telephone device. As another example, network interface 18 communicates a challenge code 38 for receipt by a card user identification device 86. Network interface 18 represents any port or connection, real or virtual, including any suitable hardware and/or software, including protocol conversion and data processing capabilities, to communicate through a local area network (LAN), a metropolitan area network (MAN), a wide area network (WAN), or other communication system that allows verification entity device 14 to exchange information with network 50, merchant verification device 54, merchant telephone device 74, network 78, card user telephone device 82, card user identification device 86, or other components of system 10.

Processor 22 communicatively couples to network interface 18 and memory unit 26, and controls the operation and administration of verification entity device 14 by processing information received from network interface 18 and memory unit 26. Processor 22 includes any hardware and/or software that operates to control and process information. For example, processor 22 executes verification entity device management application 30 to control the operation of verification entity device 14. Processor 22 may be a programmable logic device, a microcontroller, a microprocessor, any suitable processing device, or any combination of the preceding.

Memory unit 26 stores, either permanently or temporarily, data, operational software, or other information for processor 22. Memory unit 26 includes any one or a combination of volatile or non-volatile local or remote devices suitable for storing information. For example, memory unit 26 may include random access memory (RAM), read only memory (ROM), magnetic storage devices, optical storage devices, any other suitable information storage device, or any combination of the preceding. Additionally, memory unit 26 may be an encrypted storage device (or a storage device secured in any suitable manner), providing protection against fraudulent attempts to access the information stored in memory unit 26. While illustrated as including particular information modules, memory unit 26 may include any suitable information for use in the operation of verification entity device 14.

As illustrated, memory unit 26 includes verification entity device management application 30 and accounts 34. Verification entity device management application 30 represents any suitable set of instructions, logic, or code embodied in a computer-readable storage medium and operable to facilitate the operation of verification entity device 14. Accounts 34 represent any information regarding personal, commercial, and/or corporate accounts handled by verification entity device 14 with regard to one or more payment cards. For example, accounts 34 includes account numbers, nicknames for accounts, account identifiers associated with an account, balance information of an account (and/or a payment card linked to the account), limits of an account (and/or a payment card linked to the account), disclaimers associated with an account, card user preferences, data associated with one or more telephone transactions performed (or in the process of being performed) by a card user, any other suitable data, or any combination of the preceding. Account 34 for each different card user (or for each account that includes multiple authorized card users) may include challenge codes 38, comparison codes 42, and verification management application 46a.

Challenge codes 38 represent any code that may be used to interrogate card user identification device 86 for a verification code 106. Examples of challenge codes 38 are discussed in further detail below. Comparison codes 42 represent any code that may be compared to a verification code 106 in order to verify a telephone transaction. Examples of comparison codes 42 are discussed in further detail below. Verification management application 46a represents any suitable set of instructions, logic, or code embodied in a computer-readable storage medium and operable to provide a predefined manner of selecting comparison codes 42, verification codes 106, and/or verifying a telephone transaction using comparison codes 42 and verification codes 106. Examples of verification management application 46a are discussed in further detail below.

Network 50 represents any suitable network operable to facilitate communication between the components of system 10, such as verification entity device 14, network 50, merchant verification device 54, merchant telephone device 74, network 78, card user telephone device 82, and card user identification device 86. Network 50 may include any interconnecting system capable of transmitting audio, video, signals, data, messages, or any combination of the preceding. Network 50 may include all or a portion of a public switched telephone network (PSTN), a public or private data network, a LAN, a MAN, a WAN, a local, regional, or global communication or computer network, such as the Internet, a wireline or wireless network, an enterprise intranet, or any other suitable communication link, including combinations thereof, operable to facilitate communication between the components.

Merchant verification device 54 represents any suitable components that communicate with verification entity device 14 and card user identification device 86 in order to assist in the verification of telephone transactions between card users and merchants. Merchant verification device 54 may be a personal computer, a workstation, a laptop, a mobile telephone (such as a Smartphone, or any other wireless, cellular, cordless, or satellite telephone), an electronic notebook, a personal digital assistant, a transceiver node, a radio frequency transceiver, an audio-generation device (such as an audio sound modulator or an analog modem), any other device (wireless, wireline, or otherwise) capable of receiving, processing, storing, and/or communicating information with other components of system 10, or any combination of the preceding. Merchant verification device 54 may act as an intermediary between verification entity device 14 and card user identification device 86. As an example, verification entity device 14 may communicate a challenge code 38 for receipt by the card user identification device 86. In such an example, merchant verification device 54 may receive the challenge code 38 (prior to the card user identification device 86 receiving the challenge code 38) and may re-communicate the challenge code 38 for receipt by the card user identification device 86. Additionally, the card user identification device 86 may communicate a verification code 106 for receipt by the verification entity device 14. In such an example, the merchant verification device 54 may receive the verification code 106 (prior to the verification entity device 14 receiving the verification code 106) and may re-communicate the verification code 106 for receipt by the verification entity device 14.

Merchant verification device 54 may be associated with a merchant. For example, a particular merchant may be a retail chain that sells goods to card users. In such an example, this merchant may have one or more merchant verification devices 54 that allow the merchant to perform telephone transactions with a card user. The merchant verification device 54 may be connected to, combined with, or otherwise associated with the merchant telephone device 74, a cash register (or other device used to process purchases, such as a point-of-sale device) of the merchant, and/or a payment card reader (or other device used to process a payment card). As such, the merchant verification device 54 may be located at the merchant's location (and/or at the location of an employee of the merchant), and may act as an intermediary between the verification entity device 14 and the card user identification device 86. Merchant verification device 54 may include a user interface, such as a display, a microphone, a speaker, a keypad, a scanner (such as a barcode scanner), or other appropriate terminal equipment usable by a merchant or other user.

As illustrated, merchant verification device 54 includes a network interface 58, a processor 62, and a memory unit 66. Network interface 58 represents any suitable device operable to receive information from network 50 and/or network 78, transmit information through network 50 and/or network 78, perform processing of information, communicate with other devices, or any combination of the preceding. For example, network interface 58 receives a challenge code 38 from the verification entity device 14 and re-communicates the challenge code 38 for receipt by the card user identification device 86. As another example, network interface 58 receives a verification code 106 from the card user identification device 86 and re-communicates the verification code 106 for receipt by the verification entity device 14. Network interface 58 represents any port or connection, real or virtual, including any suitable hardware and/or software, including protocol conversion and data processing capabilities, to communicate through a LAN, a MAN, a WAN, or other communication system that allows network interface 58 to exchange information with verification entity device 14, network 50, merchant telephone device 74, network 78, card user telephone device 82, card user identification device 86, or other components of system 10. As an example, network interface 58 may be (or may further include) a speaker/microphone for communicating audio signals (such as audio tones) to and from the card user identification device 86.

Processor 62 communicatively couples to network interface 58 and memory unit 66, and controls the operation and administration of merchant verification device 54 by processing information received from network interface 58 and memory unit 66. Processor 62 includes any hardware and/or software that operates to control and process information. For example, processor 62 executes merchant verification device management application 70 to control the operation of merchant verification device 54. Processor 62 may be a programmable logic device, a microcontroller, a microprocessor, any suitable processing device, or any combination of the preceding.

Memory unit 66 stores, either permanently or temporarily, data, operational software, or other information for processor 62. Memory unit 66 includes any one or a combination of volatile or non-volatile local or remote devices suitable for storing information. For example, memory unit 66 may include RAM, ROM, magnetic storage devices, optical storage devices, any other suitable information storage device, or any combination of the preceding. Additionally, memory unit 66 may be an encrypted storage device (or a storage device secured in any suitable manner), providing protection against fraudulent attempts to access the information stored in memory unit 66. While illustrated as including particular information modules, memory unit 66 may include any suitable information for use in the operation of merchant verification device 54. As illustrated, memory unit 66 includes merchant verification device management application 70. Merchant verification device management application 70 represents any suitable set of instructions, logic, or code embodied in a computer-readable storage medium and operable to facilitate the operation of merchant verification device 54.

Merchant telephone device 74 represents any suitable components that provide for telephone communication (or any other verbal communication) between card users and merchants. Merchant telephone device 74 may include a landline (or wired) telephone, a mobile telephone (such as a Smartphone, or any other wireless, cellular, cordless, or satellite telephone), a voice over internet protocol (VoIP) device (such as a VoIP telephone, a personal computer with VoIP capabilities, a workstation with VoIP capabilities, a laptop with VoIP capabilities), a telephone with video capabilities, a telephone with text-based capabilities (such as text-based hearing-impaired telephones), a two-way radio device, any other device (wireless, wireline, or otherwise) capable of providing for telephone communication (or other verbal communication) between card users and merchants, or any combination of the preceding.

Merchant telephone device 74 may be associated with a merchant. For example, a particular merchant may be a retail chain that sells goods to card users. In such an example, this merchant may have one or more merchant telephone devices 74 that allow the merchant to receive/place calls with customers, communicate with customers, and/or perform telephone transactions with a card user (or other customer). As such, the merchant telephone device 74 may be located at the merchant's location (and/or at the location of an employee of the merchant). Merchant telephone device 74 may include a user interface, such as a display, a keypad, a microphone, an earphone, a speaker, a headset, or other appropriate terminal equipment usable by a merchant or other user.

As illustrated, merchant telephone device 74 is communicatively coupled to merchant verification device 54. Merchant telephone device 74 may communicate with merchant verification device 54 (or vice versa) in any suitable manner. For example, merchant telephone device 74 may include (or be coupled to) one or more interfaces, connections, or ports (such as an audio input port) that may communicatively couple merchant verification device 54 to merchant telephone device 74. In such an example, the merchant verification device 54 may be plugged into the interface, connection, or port, allowing the merchant verification device 54 to communicate with (or through) the merchant telephone device 74. As another example, a user of merchant verification device 54 and/or merchant telephone device 74 may position merchant verification device 54 in a close proximity to merchant telephone device 74 so that audio signals generated and/or transmitted by merchant verification device 54 may be received by the merchant telephone device 74. In such an example, the merchant (or other user) may hold the merchant verification device 54 up to (or otherwise position the merchant verification device 54 near) the microphone/speaker of the merchant telephone device 74 so that the microphone/speaker may hear (or otherwise receive) an audio signal generated by the merchant verification device 54 (or so that the merchant verification device 54 may hear, or otherwise receive, an audio signal communicated by the merchant telephone device 74). As another example, merchant telephone device 74 and merchant verification device 54 may be communicatively coupled through a network similar to network 50 (discussed above) and/or network 78 (discussed below). In such an example, merchant telephone device 74 and merchant verification device 54 may be communicatively coupled through a wireless network (such as a Bluetooth network, a WiFi network, a radio frequency identification network, or an infrared network).

Although merchant telephone device 74 is illustrated as a separate device from merchant verification device 54, merchant telephone device 74 may the same device as merchant verification device 54. In such an example, a single device may be used to provide for telephone communication between card users and merchants, and also to communicate with verification entity device 14 and card user identification device 86 in order to assist in the verification of telephone transactions between card users and merchants. As an example, the merchant telephone device 74 may be mobile phone running a mobile phone application that allows the merchant telephone device 74 to perform one or more (or all) of the functions of the merchant verification device 54.

Network 78 represents any suitable network operable to facilitate a telephone communication (or any other communication) between the components of system 10, such as merchant telephone device 74 and card user telephone device 82. Network 78 may include any interconnecting system capable of transmitting audio, video, signals, data, messages, or any combination of the preceding. Network 78 may include all or a portion of a PSTN, a public or private data network, a LAN, a MAN, a WAN, a local, regional, or global communication or computer network, such as the Internet, a wireline or wireless network, an enterprise intranet, or any other suitable communication link, including combinations thereof, operable to facilitate a telephone communication (or any other communication) between the components of system 10. Furthermore, network 78 may be the same type of network as network 50, or network 78 may be a different type of network than network 50. For example, both network 78 and network 50 may be a combination of wireless and wireline networks. As another example, network 78 may be only a PSTN network (or only a wireless network), while network 50 may be a combination of wireless and wireline networks. Additionally, although network 78 and network 50 are illustrated as separate networks, network 78 and network 50 may be the same network. In such an example, a single network may communicate a challenge code 38 from verification entity device 14 to merchant verification device 54, and may further re-communicate the challenge code 38 from merchant telephone device 74 to card user telephone device 82.

Card user telephone device 82 represents any suitable components that provide for telephone communication between card users and merchants. Card user telephone device 82 may include a landline (or wired) telephone, a mobile telephone (such as a Smartphone, or any other wireless, cellular, cordless, or satellite telephone), a voice over internet protocol (VoIP) device (such as a VoIP telephone, a personal computer with VoIP capabilities, a workstation with VoIP capabilities, a laptop with VoIP capabilities), a telephone with video capabilities, a telephone with text-based capabilities (such as text-based hearing-impaired telephones), a two-way radio device, any other device (wireless, wireline, or otherwise) capable of providing for telephone communication (or other verbal communication) between card users and merchants, or any combination of the preceding. Card user telephone device 82 may include a user interface, such as a display, a keypad, a microphone, an earphone, a speaker, a headset, or other appropriate terminal equipment usable by a card user.

Card user telephone device 82 may be associated with a card user. For example, the card user may own (or have access to) the card user telephone device 82 in order to conduct telephone communications (or other verbal communications). As such, the card user telephone device 82 may be located at the card user's location. The card user may utilize the card user telephone device 82 to communicate with the merchant (via network 78 and merchant telephone device 74) in order to perform (or attempt to perform) a telephone transaction with the merchant.

Card user identification device 86 represents any suitable components that communicate with merchant verification device 54 in order to provide verification codes 106 to the verification entity device 14 to verify telephone transactions between card users and merchants. Card user identification device 86 may be a personal computer, a workstation, a laptop, a mobile telephone (such as a Smartphone, or any other wireless, cellular, cordless, or satellite telephone), an electronic notebook, a personal digital assistant, a transceiver node, an audio-generation device (such as an audio sound modulator or an analog modem), any other device (wireless, wireline, or otherwise) capable of receiving, processing, storing, and/or communicating information with merchant verification device 54 (and/or other components of system 10), or any combination of the preceding. Additionally, the card user identification device 86 may include a user interface, such as a display, a microphone, a speaker, a keypad, a scanner (such as a barcode scanner), or other appropriate terminal equipment usable by a card user.

Card user identification device 86 may be carried by the card user (or otherwise associated with the card user). As such, when the card user attempts to conduct a telephone transaction with a merchant using payment card information (or the payment card), card user identification device 86 may communicate with merchant verification device 54 (and verification entity device 14) in order to provide verification codes 106 that may allow the verification entity device 14 to verify the telephone transaction. Card user identification device 86 may be carried by the card user (or otherwise associated with the card user) in any suitable manner. For example, the card user identification device 86 may be an audio-generation device that is attached to the card user's keys, wallet, purse, wearable items (such as a wearable wristband), and/or article of clothing (such as a belt). As another example, the card user identification device 86 may be an audio-generation device that is stored (or otherwise positioned) near the card user telephone device 82. As a further example, the card user identification device 86 may be the card user's mobile phone.

As illustrated, card user identification device 86 includes a network interface 90, a processor 94, and a memory unit 98. Network interface 90 represents any suitable device operable to receive information from network 78, transmit information through network 78, perform processing of information, communicate to other devices, or any combination of the preceding. For example, network interface 90 receives a challenge code 38 from the verification entity device 14 (via the merchant verification device 54, merchant telephone device 74, network 78, and card user telephone device 82) and communicates a verification code 106 to the verification entity device 14 (via the card user telephone device 82, network 78, merchant telephone device 74, and merchant verification device 54). Network interface 90 represents any port or connection, real or virtual, including any suitable hardware and/or software, including protocol conversion and data processing capabilities, to communicate through a LAN, a MAN, a WAN, or other communication system that allows network interface 90 to exchange information with verification entity device 14, network 50, merchant verification device 54, merchant telephone device 74, network 78, card user telephone device 82, or other components of system 10. As an example, network interface 58 may be (or may further include) a speaker/microphone for communicating audio signals (such as audio tones) to and from the merchant verification device 54.

Processor 94 communicatively couples to network interface 90 and memory unit 98, and controls the operation and administration of card user identification device 86 by processing information received from network interface 90 and memory unit 98. Processor 94 includes any hardware and/or software that operates to control and process information. For example, processor 94 executes card user identification device management application 102 to control the operation of card user identification device 86. Processor 94 may be a programmable logic device, a microcontroller, a microprocessor, any suitable processing device, or any combination of the preceding.

Memory unit 98 stores, either permanently or temporarily, data, operational software, or other information for processor 94. Memory unit 98 includes any one or a combination of volatile or non-volatile local or remote devices suitable for storing information. For example, memory unit 98 may include RAM, ROM, magnetic storage devices, optical storage devices, any other suitable information storage device, or any combination of the preceding. Additionally, memory unit 98 may be an encrypted storage device (or a storage device secured in any suitable manner), providing protection against fraudulent attempts to access the information stored in memory unit 98. While illustrated as including particular information modules, memory unit 98 may include any suitable information for use in the operation of card user identification device 86.

As illustrated, memory unit 98 includes card user identification device management application 102, verification codes 106, and verification management application 46b. Card user identification device management application 102 represents any suitable set of instructions, logic, or code embodied in a computer-readable storage medium and operable to facilitate the operation of card user identification device 86. Verification codes 106 represent any code that may be used to identify the card user as the approved user of the payment card (as opposed to another person who may have fraudulently obtained the payment card). Examples of verification codes 106 are discussed in further detail below. Verification management application 46b may be substantially similar to verification management application 46a (stored in memory unit 26 of verification entity device 14). As such, verification management application 46b represents any suitable set of instructions, logic, or code embodied in a computer-readable storage medium and operable to provide a predefined manner of selecting verification codes 106. Verification management application 46b may be received by (and stored by) card user identification device 86 prior to card user identification device 86 receiving a challenge code 38. For example, verification management application 46b may be received by (and stored by) card user identification device 86 when card user identification device 86 is manufactured, programmed, and/or updated to operate with system 10. Furthermore, verification management application 46b may be received by (and stored by) card user identification device 86 at any other time. For example, verification management application 46b may be a portion of the challenge code 38 communicated for receipt by the card user identification device 86. In such an example, the card user identification device 86 may receive (and store) the verification management application 46b the first time it receives the challenge code 38 (or every time it receives the challenge code 38). As another example, verification management application 46b may be communicated to the card user identification device 86 in the same message as a challenge code 38, in a message prior to the communication of the challenge code 38, or in a message after the communication of the challenge code 38. As such, the card user identification device 86 may receive (and store) the verification management application 46b prior to receiving a challenge code 38, at the same time (or substantially the same time) as receiving a challenge code 38, or after receiving a challenge code 38. Examples of verification management application 46b are discussed in further detail below.

As illustrated, card user identification device 86 is communicatively coupled to the card user telephone device 82. Card user identification device 86 may communicate with the card user telephone device 82 (or vice versa) in any suitable manner. For example, card user telephone device 82 may include (or be coupled to) one or more interfaces, connections, or ports (such as an audio input port) that may communicatively couple card user identification device 86 to card user telephone device 82. In such an example, the card user identification device 86 may be plugged into the interface, connection, or port, allowing the card user identification device 86 to communicate with (or through) the card user telephone device 82. As another example, a user of card user identification device 86 and/or card user telephone device 82 may position card user identification device 86 in a close proximity to card user telephone device 82 so that audio signals generated and/or transmitted by card user identification device 86 may be received by the card user telephone device 82. In such an example, the card user (or other user) may hold the card user identification device 86 up to (or otherwise position the card user identification device 86 near) the microphone/speaker of the card user telephone device 82 so that the microphone/speaker may hear (or otherwise receive) an audio signal generated by the card user identification device 86 (or so that the card user identification device 86 may hear, or otherwise receive, an audio signal communicated by the merchant verification device 54). As another example, card user identification device 86 and card user telephone device 82 may be communicatively coupled through a network similar to network 50 (discussed above) and/or network 78 (also discussed above). In such an example, card user identification device 86 and card user telephone device 82 may be communicatively coupled through a wireless network (such as a Bluetooth network, a WiFi network, a radio frequency identification network, or an infrared network).

Although card user identification device 86 is illustrated as a separate device from card user telephone device 82, card user identification device 86 may the same device as card user telephone device 82. In such an example, a single device may be used to provide for telephone communication between card users and merchants, and also to communicate with merchant verification device 54 in order to provide verification codes 106 to the verification entity device 14 to verify telephone transactions between card users and merchants. As an example, the card user telephone device 82 may be mobile phone running a mobile phone application that allows the card user telephone device 82 to perform one or more (or all) of the functions of the card user identification device 86.

In an exemplary embodiment of operation, a card user may desire to conduct a telephone transaction with a particular merchant. For example, a card user may desire to purchase an item (such as a shirt) using a payment card (such as a credit card) and a card user telephone device 82 (such as the card user's mobile phone). In order to do so, the card user may make a telephone call to the merchant, and may provide the merchant with payment card information (via telephone payment 150). As a result of receiving the payment card information, the merchant may provide the payment card information to the merchant verification device 54 (via payment entry 154), which may provide an indication (via indication 158) to verification entity device 14 that the card user is attempting to perform a telephone transaction with the merchant using the payment card.

In order to protect against fraud, the verification entity (such as a credit card company or a clearinghouse that communicates with a credit card company) may desire to verify that the person attempting to perform the telephone transaction using the payment card is the card user that is authorized to use the payment card. For example, the credit card company may desire to verify that a card issued to John Doe is being used by John Doe, as opposed to someone that may have fraudulently obtained the card (or information about the card) issued to John Doe. To verify the identity of the person using the payment card, verification entity device 14 may communicate a challenge code 38 configured to interrogate a card user identification device 86 carried by (or otherwise associated with) the card user, such as an audio-generation device that is attached to the keys of John Doe. The challenge code 38 may be first communicated to merchant verification device 54 (via first challenge message 162). Following receipt of the challenge code 38, merchant verification device 54 may re-communicate the challenge code 38 to merchant telephone device 74 (via second challenge message 166), such as by generating an audio signal for communication to the merchant telephone device 74. The merchant telephone device 74 may then re-communicate the challenge code 38 to card user telephone device 82 (via third challenge message 170), which may re-communicate the challenge code 38 to the card user identification device 86 (via fourth challenge message 174) carried by the card user, such as the audio-generation device that is attached to the keys of John Doe. The challenge code 38 may interrogate the card user identification device 86, causing the card user identification device 86 to select a verification code 106 (via a predefined manner of verification management application 46b). The card user identification device 86 may then communicate the verification code 106 to the card user telephone device 82 (via first verification response message 178), such as by generating an audio signal for communication to the card user telephone device 82. The card user telephone device 82 may re-communicate the verification code 106 to the merchant telephone device 74 (via second verification response message 182), which may re-communicate the verification code 106 to the merchant verification device 54 (via third verification response message 186). The merchant verification device 54 may receive the verification code 106 and then re-communicate the verification code 106 to verification entity device 14 (via fourth verification response message 190).

Following receipt of verification code 106, verification entity device 14 may select a comparison code 42 (via the predefined manner of verification application 46a) to compare to the verification code 106 received from the card user identification device 86. If the verification code 106 does not match the comparison code 42 (or a verification code 106 is never received in response to a challenge code 38), verification entity device 14 may deny the processing of the telephone transaction. On the other hand, if the verification code 106 does match the comparison code 42, verification entity device 14 may verify the telephone transaction (or otherwise approve the processing of the telephone transaction) via verification signal 194 communicated to merchant verification device 54, and the telephone transaction may be allowed to occur. In particular embodiments, this method of verifying a telephone transaction may provide additional protection against fraud. For example, even if a person (or a device) is able to steal or copy a card user's payment card information (such as the payment card number, expiration date, and verification code) or the payment card (itself), the person may be unable to conduct one or more telephone transactions using the payment card information (or the payment card) because the person may not also have the card user identification device 86. As another example, even if a person (or a device) is also able to attempt to respond to a challenge code 38 using a fraudulent device, the code provided by the fraudulent device may not match the comparison code 42 utilized by the verification entity device 14 because the fraudulent device may not have access to verification codes 106 or the verification management application 46b that results in a verification code 106 being selected in a predefined manner. Further details regarding particular examples of these sequences illustrated in FIG. 1 are discussed below.

As is stated above, a card user may initiate a telephone transaction with a merchant by providing payment card information to the merchant via telephone payment 150. Telephone payment 150 may be performed in any suitable manner. As an example, the card user may call the merchant (or an employee of the merchant) on the card user telephone device 82, may verbally communicate what goods or services the card user desires to purchase, and may verbally communicate the payment card information to the merchant. As a further example, the payment card information may already be saved (or otherwise on file with the merchant). In such an example, telephone payment 150 may be performed by the card user verbally communicating their name (or other identifying information), which may allow the merchant to look-up (or otherwise access) the already saved payment card information.

Following receipt of telephone payment 150, the merchant may provide the payment card information to merchant verification device 54 via payment entry 154. Payment entry 154 may be performed in any suitable manner. As an example, the merchant may enter the payment card information directly into merchant verification device 54 by, for example, typing (or otherwise pressing one or more buttons) the payment card information into the merchant verification device 54. As another example, the merchant may enter the payment card information indirectly into merchant verification device 54 by, for example, typing (or otherwise pressing one or more buttons) the payment card information into a payment device (such as a cash register), which may then communicate the payment card information to merchant verification device 54. As a further example, the merchant may enter the payment card information indirectly into merchant verification device 54 by, for example, looking-up (or otherwise accessing) the payment card information saved (or otherwise on file) with the payment device (such as the cash register), which may then communicate the payment card information to merchant verification device 54.

As a result of merchant verification device 54 receiving the payment card information, merchant verification device 54 may communicate indication 158 to verification entity device 14, indicating that that the card user is attempting to perform a telephone transaction with the merchant using the payment card. Indication 158 may include any information about the attempted telephone transaction. For example, indication 158 may include all (or a portion) of the payment card information received by the merchant verification device 54, information associated with the merchant (such as information that identifies the merchant), information associated with the telephone transaction (such as the purchase amount for the telephone transaction and details about what is being purchased), any other information desired by a verification entity for approving a telephone transaction, or any combination of the preceding.

Although indication 158 has been illustrated as being communicated directly from merchant verification device 54 to verification entity device 14, in particular embodiments, indication 158 may be communicated to one or more additional devices (not shown) before indication 158 is received by verification entity device 14. For example, indication 158 may first be communicated to a payment processor (such as a payment processing system run by, for example, First Data Merchant Services Corporation), and then the payment processor may re-communicate the indication 158 to verification entity device 14. The payment processor may re-communicate all or a portion of indication 158. Additionally, the payment processor may perform one or more payment processing actions (using the information in indication 158) prior to re-communicating indication 158. In such an example, the payment processor may add information associated with these additional payment processing actions to indication 158 prior to re-communicating indication 158 to verification entity device 14. Furthermore, although the indication 158 has been illustrated as being communicated to the verification entity device 14 by merchant verification device 54, in particular embodiments, the indication 158 may be communicated to the verification entity device 14 by the payment device (such as the cash register), thereby bypassing merchant verification device 54.

Following receipt of indication 158, verification entity device 14 may communicate a challenge code 38 (via first challenge message 162) for receipt by the card user identification device 86. As is discussed above, a challenge code 38 represents any code that may be used to interrogate card user identification device 86 for a verification code 106. For example, a challenge code 38 may be a computer-readable code that forces, requests, or causes a response from card user identification device 86. In such an example, the challenge code 38 may force, request, or cause the card user identification device 86 to select a verification code 106 stored at the card user identification device 86 and communicate the verification code 106 for receipt by the verification entity device 14.

A challenge code 38 may be the same code for all card user identification devices 86, or may be unique for each card user identification device 86 (or for one or more card user identification devices 86). For example, a challenge code 38 for a card user identification device 86 carried by John Doe may be different than a challenge code 38 for a card user identification device 86 carried by Jane Doe. Challenge code 38 may be the same challenge code every time it is sent for receipt by a particular card user identification device 86, or it may be different every time it is sent for receipt by a particular card user identification device 86. For example, challenge code 38 may include one or more details associated with the telephone transaction (such as the purchase amount, the merchant identification, the time and/or date associated with the telephone transaction or the challenge code 38, etc.), thereby causing it to be different every time it is sent for receipt by the card user identification device 86 carried by John Doe. As another example, the challenge code 38 may include a particular verification management application 46b for use by the card user identification device 86 for that telephone transaction. As a further example, the challenge code 38 may include particular instructions for responding to the challenge code 38 (such as a particular question that is to be answered using the verification code 106).

Following communication of challenge code 38 for receipt by a card user identification device 86, the challenge code 38 may be received by merchant verification device 54 (via first challenge message 162). Merchant verification device 54 may act as an intermediary between verification entity device 14 and card user identification device 86. By doing so, merchant verification device 54 may receive the challenge code 38 from verification entity device 14 (via first challenge message 162) and re-communicate the challenge code 38 for receipt by card user identification device 86 (via second challenge message 166, third challenge message 170, and fourth challenge message 174). Merchant verification device 54 may re-communicate challenge code 38 in the same form (and/or in the same manner) in which merchant verification device 54 received the challenge code 38. For example, merchant verification device 54 may act as an amplifier (or an access point) that provides a network connection between verification entity device 14 and card user identification device 86. Additionally (or alternatively), merchant verification device 54 may re-communicate challenge code 38 in a different form (and/or in a different manner) than what merchant verification device 54 received the challenge code 38 as. For example, merchant verification device 54 may receive the challenge code 38 in digital form over a wired connection and re-communicate the challenge code 38 in analog form over a wireless connection. As another example, merchant verification device 54 may receive the challenge code 38 in digital form over a wireless connection and re-communicate the challenge code 38 as an audio signal. As a further example, merchant verification device 54 may receive the challenge code 38 in a digital form over a wired connection and re-communicate the challenge code 38 as a graphical image (such as a barcode, a QR code, a universal product code (UPC), a matrix bar code, a MaxiCode, or a ShotCode) that may be scanned or copied by the merchant telephone device 74 for transmittal to the card user telephone device 82 and the card user identification device 86. In such examples, merchant verification device 54 may act as a converter to convert challenge code 38 from a form (and/or a communication manner) that cannot be received by the card user identification device 86 to a form (and/or a communication manner) that can be received by the card user identification device 86.

As illustrated, merchant verification device 54 re-communicates the challenge code 38 as an audio tone (or other audio signal). For example, merchant verification device 54 be an audio-generation device that is held (or otherwise positioned) by the merchant in close proximity to merchant telephone device 74 so that audio tones (which include the challenge code 38) generated and/or transmitted by the merchant verification device 54 may be received by the merchant telephone device 74 (via, for example, a microphone/speaker in the merchant telephone device 74).

Following receipt of the challenge code 38 from the merchant verification device 54, the merchant telephone device 74 may re-communicate the challenge code 38 to the card user telephone device 82 (via third challenge message 170). Merchant telephone device 74 may re-communicate challenge code 38 in the same form (and/or in the same manner) in which merchant telephone device 74 received the challenge code 38. For example, merchant telephone device 74 may receive the challenge code as an audio signal, and may re-communicate the challenge code 38 as the audio signal. Additionally (or alternatively), merchant telephone device 74 may re-communicate challenge code 38 in a different form (and/or in a different manner) than what merchant telephone device 74 received the challenge code 38 as. For example, merchant telephone device 74 may receive the challenge code 38 in digital form over a wired connection and re-communicate the challenge code 38 as an audio signal. As a further example, merchant telephone device 74 may receive the challenge code 38 in a digital form over a wired connection and re-communicate the challenge code 38 as a graphical image.

Following receipt of the challenge code 38 from the merchant telephone device 74, the card user telephone device 82 may re-communicate the challenge code 38 to the card user identification device 86 (via fourth challenge message 174). Card user telephone device 82 may re-communicate challenge code 38 in the same form (and/or in the same manner) in which card user telephone device 82 received the challenge code 38. For example, card user telephone device 82 may receive the challenge code as an audio signal, and may re-communicate the challenge code 38 as the audio signal. Additionally (or alternatively), card user telephone device 82 may re-communicate challenge code 38 in a different form (and/or in a different manner) than what card user telephone device 82 received the challenge code 38 as. For example, card user telephone device 82 may receive the challenge code 38 in digital form over a wireless connection and re-communicate the challenge code 38 as an audio signal. As a further example, merchant telephone device 74 may receive the challenge code 38 in a digital form over a wireless connection and re-communicate the challenge code 38 as a graphical image.

As illustrated, card user telephone device 82 re-communicates the challenge code 38 as an audio tone (or other audio signal). For example, the card user identification device 86 may be held (or otherwise positioned) by the card user in close proximity to the card user telephone device 82 so that audio tones (which include the challenge code 38) generated and/or transmitted by the card user telephone device 82 (such as, for example, transmitted by a speaker in the card user telephone device 82) may be received by the card user identification device 86 (such as, for example, received by a microphone/speaker in the card user identification device 86).

Although challenge code 38 has been illustrated as being indirectly communicated from verification entity device 14 to card user identification device 86 (via various devices and various messages), in particular embodiments, the challenge code 38 may be communicated directly from verification entity device 14 to the card user identification device 86. For example, the card user identification device 86 may be a mobile phone that receives the challenge code 38 directly. In such an example, the mobile phone may be running a mobile phone application associated with the verification entity device 14, and the verification entity device 14 may push the challenge code 38 directly to the mobile phone. Furthermore, the card user identification device 86 (such as a mobile phone) may be connected directly to the verification entity device 14 via a communication network, such as a network similar to network 50 (discussed above). In response to receiving the challenge code 38 directly from the verification entity device 14, the card user identification device 86 may communicate a verification code 106 to the merchant verification device 54 (either directly or via various devices and/or messages), which may then re-communicate the verification code 106 to the verification entity device 14.

Furthermore, although challenge code 38 has been illustrated as being automatically re-communicated from the merchant verification device 54 to the card user identification device 86, in particular embodiments, the re-communication (and/or even the original communication) of the challenge code 38 to the card user identification device 86 may only occur after a signal is first received from the card user identification device 86. For example, before the challenge code 38 may be received by the card user identification device 86 (and/or even communicated to the card user identification device 86), the card user may activate the card user identification device 86 (such as by pushing a button on the card user identification device 86 or performing any other user action with the card user identification device 86). This activation by the card user may cause the card user identification device 86 to send a signal to the merchant verification device 54 (and/or the verification entity device 14) indicating that the card user identification device 86 is ready to receive the challenge code 38. Following receipt of this signal from the card user identification device 86, the challenge code 38 may be communicated to (and received by) the card user identification device 86.

Following receipt of the challenge code 38 by the card user identification device 86, the card user identification device 86 may (in response to the interrogation provided by the challenge code 38) select one of the verification codes 106 stored at the card user identification device 86. Furthermore, the card user identification device 86 may communicate the verification code 106 for receipt by the verification entity device 14. As is discussed above, a verification code 106 represents any code that may be used to identify the card user as the approved user of the payment card (as opposed to another person who may have fraudulently obtained the payment card information and/or the payment card). For example, a verification code 106 may be a predefined code stored at the card user identification device 86, and may be configured to match a comparison code 42 stored at the verification entity device 14. The verification code 106 may be a password, a set of numbers, a set of alphanumeric characters, a set of symbols, one or more audible tones, one or more radio frequencies, one or more graphical images, any other type of code or representation, or any combination of the preceding. The verification code 106 may have any length, size, or dimension. For example, the verification code 106 may be a 35 character password.

The verification code 106 may match a comparison code 42 when all or a portion of the verification code 106 is identical to all or a portion of the comparison code 42. For example, the verification code 106 may match the comparison code 42 when the last 30 digits of the verification code 106 are identical to the last 30 digits of the comparison code 42. Additionally (or alternatively), the verification code 106 may match a comparison code 42 when the verification code 106 is an answer to the comparison code 42 (such as an answer to a question), when the verification code 106 completes the comparison code 42 (such as a final piece of a puzzle), when the verification code 106 is the opposite of the comparison code 42 (such as the term “up” is the opposite of “down”), any other manner of matching, or any combination of the preceding.

Card user identification device 86 may store any suitable number of different verification codes 106. For example, card user identification device 86 may store 2 different verification codes 106, 5 different verification codes 106, 10 different verification codes 106, 15 different verification codes 106, 25 different verification codes 106, 50 different verification codes 106, 100 different verification codes 106, 1,000 different verification codes 106, 10,000 different verification codes 106, 1 million different verification codes 106, or any other number of different verification codes 106. Furthermore, following receipt of the challenge code 38 by the card user identification device 86, the card user identification device 86 may select one of the verification codes 106 stored at the card user identification device 86. The card user identification device 86 may select one of the verification codes 106 according to a predefined manner based on verification management application 46b. For example, card user identification device 86 may select one of the verification codes 106 by sequentially rotating through each of the verification codes 106 (e.g., rotating from a first code to a second code), by skipping over a predefined number of the verification codes 106 (e.g., skipping from the first code to the fifth code), by selecting a position of one of the verification codes 106 (e.g., selecting the code positioned in column five, row ten), any other manner of selecting one of the verification codes 106 according to a predefined manner based on verification management application 46b, or any combination of the preceding. Furthermore, selection of the verification code 106 may further include modifying the verification code 106. For example, the verification code 106 may be modified to include information from the challenge code 38, such as all or a portion of the challenge code 38, or details associated with the telephone transaction (e.g., the purchase amount, the merchant identification, the date and/or time associated with the telephone transaction or the challenge code 38, etc.). As another example, the verification code 106 may be modified to include information regarding the date and/or time associated with the selection of the verification code 106. Further details regarding examples of the selection of a verification code 106 are discussed below with regard to FIG. 2.

Following the selection of the verification code 106, the card user identification device 86 may communicate the verification code 106 to the card user telephone device 82 (via first verification response message 178). The card user identification device 86 may communicate the verification code 106 to the card user telephone device 82 in any suitable manner (and/or any suitable form). As an example, the card user identification device 86 may communicate the verification code 106 to the card user telephone device 82 in the same manner of communication (and/or form) by which the card user identification device 86 received the challenge code 38. In such an example, if the card user identification device 86 received the challenge code 38 as an audio signal, the card user identification device 86 may communicate the verification code 106 to the card user telephone device 82 as an audio signal. As another example, the card user identification device 86 may communicate the verification code 106 to the card user telephone device 82 in a different manner of communication (and/or form) than that by which the card user identification device 86 received the challenge code 38. In such an example, if the card user identification device 86 received the challenge code 38 in a particular radio frequency, the card user identification device 86 may communicate the verification code 106 to the merchant verification device 54 in a different radio frequency, an audio signal, a graphical image displayed or sent to the card user telephone device 82, any other manner (and/or form) different from that by which the card user identification device 86 received the challenge code 38, or any combination of the preceding. As illustrated, card user identification device 86 communicates the verification code 106 as an audio tone (or any other audio signal). For example, the card user identification device 86 may be held (or otherwise positioned) by the card user in close proximity to card user telephone device 82 so that audio tones (which include the verification code 106) generated and/or transmitted by the card user identification device 86 (such as, for example, transmitted by a speaker in the card user identification device 86) may be received by the card user telephone device 82 (such as, for example, received by a microphone/speaker in the card user telephone device 82).

Furthermore, the selection and communication processes of the verification code 106 by the card user identification device 86 may occur without user intervention. For example, following the reception of the challenge code 38 by the card user identification device 86, the card user identification device 86 may both automatically select and communicate the verification code 106 without any intervention by the card user (e.g., without the card user pressing a button, confirming a selection, pointing the card user identification device 86 in a particular direction, scanning the card user identification device 86, etc.). As such, verifying the telephone transaction using the card user identification device 86 may occur without any action by the user, other than the card user actually carrying the card user identification device 86 with them when performing the telephone transaction (such as carrying the card user identification device 86 in the card user's purse or attached to the card user's keys) and/or other than the card user performing the telephone transaction with a card user identification device 86 that is held (or otherwise positioned) within communication range to the card user telephone device 82 (such as within Bluetooth range, WiFi range, radio frequency identification range, infrared range, sound wave range, or any other suitable range). Alternatively, one or more (or both) of the selection and communication processes of the verification code 106 by the card user identification device 86 may occur with user intervention. For example, selection of the verification code 106 may occur when the card user presses a button on the card user identification device 86 to select the verification code 106, when the card user performs any other manner of user intervention, or any combination of the preceding. As another example, communication of the verification code 106 may occur when the card user presses a button to communicate the verification code 106, when the card user performs any other manner of user intervention, or any combination of the preceding.

Following receipt of the verification code 106 from the card user identification device 86 (via first verification response message 178), the card user telephone device 82 may re-communicate the verification code 106 to the merchant telephone device 74 (via second verification response message 182). The card user telephone device 82 may re-communicate the verification code 106 in the same form (and/or in the same manner) in which the card user telephone device 82 received the verification code 106. For example, the card user telephone device 82 may receive the verification code 106 as an audio signal, and may re-communicate the verification code 106 as the audio signal. Additionally (or alternatively), the card user telephone device 82 may re-communicate verification code 106 in a different form (and/or in a different manner) than what card user telephone device 82 received the verification code 106 as. For example, the card user telephone device 82 may receive the verification code 106 as an audio signal and re-communicate the verification code 106 in digital form over a wireless connection. As a further example, the card user telephone device 82 may receive the verification code 106 in a digital form over a wireless connection and re-communicate the verification code 106 as a graphical image.

Following receipt of the verification code 106 from the card user telephone device 82 (via second verification response message 182), the merchant telephone device 74 may re-communicate the verification code 106 to the merchant verification device 54 (via third verification response message 186). The merchant telephone device 74 may re-communicate the verification code 106 in the same form (and/or in the same manner) in which the merchant telephone device 74 received the verification code 106. For example, the merchant telephone device 74 may receive the verification code 106 as an audio signal, and may re-communicate the verification code 106 as the audio signal. Additionally (or alternatively), the merchant telephone device 74 may re-communicate verification code 106 in a different form (and/or in a different manner) than what the merchant telephone device 74 received the verification code 106 as. For example, the merchant telephone device 74 may receive the verification code 106 in digital form over a wireless connection and re-communicate the verification code 106 as an audio signal. As a further example, the merchant telephone device 74 may receive the verification code 106 in a digital form over a wireless connection and re-communicate the verification code 106 as a graphical image. As illustrated, merchant telephone device 74 communicates the verification code 106 as an audio tone (or any other audio signal). For example, the merchant verification device 54 may be held (or otherwise positioned) by the merchant in close proximity to merchant telephone device 74 so that audio tones (which include the verification code 106) generated and/or transmitted by the merchant telephone device 74 (such as, for example, transmitted by a speaker in the merchant telephone device 74) may be received by the merchant verification device 54 (such as, for example, received by a microphone/speaker in the merchant verification device 54).

Following receipt of the verification code 106 by merchant verification device 54 (via third verification response message 186), the merchant verification device 54 may re-communicate the verification code 106 for receipt by the verification entity device 14 (via fourth verification response message 190). Merchant verification device 54 may re-communicate the verification code 106 in the same form (and/or communication manner) in which merchant verification device 54 received the verification code 106. Furthermore (or alternatively), merchant verification device 54 may re-communicate the verification code 106 in a different form (and/or manner) than by which the merchant verification device 54 received the verification code 106. For example, if the merchant verification device 54 received the verification code 106 as an audio signal, the merchant verification device 54 may re-communicate the verification code 106 to the verification entity device 14 via a wired internet connection. In such an example, merchant verification device 54 may act as a converter to convert verification code 106 from a form (and/or communication manner) that cannot be received by the verification entity device 14 to a form (or communication manner) that can be received by the verification entity device 14.

Following receipt of the verification code 106 by the verification entity device 14, the verification entity device 14 may select one of the comparison codes 42 stored at the verification entity device 14 for comparison with the verification code 106. As is discussed above, a comparison code 42 represents any code that may be compared to a verification code 106 in order to verify a telephone transaction. For example, a comparison code 42 may be predefined code stored at the verification entity device 14 and that is configured to match a verification code 106 stored at the card user identification device 86. Similar to the verification code 106, the comparison code 42 may be a password, a set of numbers, a set of alphanumeric characters, a set of symbols, one or more audible tones, one or more radio frequencies, one or more graphical images, any other type of code or representation, or any combination of the preceding. The comparison code 42 may have any length, size, or dimension. For example, the comparison code 42 may be a 35 character password. The comparison code 42 may match a verification code 106 when all or a portion of the comparison code 42 is identical to all or a portion of the verification code 106. Additionally, the comparison code 42 may match a verification code 106 in any of the manners of matching discussed above with regard to verification codes 106.

Verification entity device 14 may store (for each account 34) any suitable number of different comparison codes 42. For example, verification entity device 14 may store (for each account 34) 2 different comparison codes 42, 5 different comparison codes 42, 10 different comparison codes 42, 15 different comparison codes 42, 25 different comparison codes 42, 50 different comparison codes 42, 100 different comparison codes 42, 1,000 different comparison codes 42, 10,000 different comparison codes 42, 1 million different comparison codes 42, or any other number of different comparison codes 42. As another example, verification entity device 14 may store (for each account 34) a matching comparison code 42 for each verification code 106 stored by the card user identification device 86 (and associated with an account 34). In such an example, if the card user identification device 86 stores 10 different verification codes 106, the verification entity device 14 may store 10 matching comparison codes 42.

The verification entity device 14 may select one of the comparison codes 42 according to the same predefined manner utilized by the card user identification device 86. For example, if the card user identification device 86 selects one of the verification codes 106 by sequentially rotating through each of the verification codes 106 (e.g., rotating from a first code to a second code), the verification entity device 14 may select one of the comparison codes 42 by sequentially rotating through each of the comparison codes 42 (e.g., rotating from a first code to a second code). As such, both the card user identification device 86 and the verification entity device 14 may utilize the same predefined manner (based on verification management applications 46b and 46a, respectively) to select a matching verification code 106 and comparison code 42. Furthermore, selection of the comparison code 42 may further include modifying comparison code 42. For example, the comparison code 42 may be modified to include information from the challenge code 38, such as all or a portion of the challenge code 38, or details associated with the telephone transaction (e.g., the purchase amount, the merchant identification, the time and/or date associated with the telephone transaction or the challenge code 38, etc.). As another example, the comparison code 42 may be modified to include information regarding the date and/or time associated with the reception of the verification code 106. Further details regarding examples of the selection of a comparison code 42 are discussed below with regard to FIG. 2.

Although the verification entity device 14 has been discussed above as selecting one of the comparison codes 42 according to the same predefined manner utilized by the card user identification device 86, in particular embodiments, the verification entity device 14 may select one of the comparison codes 42 in a different predefined manner than the card user identification device 86 (but in a manner that still causes the selected comparison code 42 to match the selected verification code 106). For example, the verification entity device 14 may store the comparison codes 42 in a different order than the card user identification device 86 stores the matching verification codes 106. In such an example, the verification entity device 14 may select the comparison code 42 using a first predefined manner (such as by sequentially rotating through each of the comparison codes 42, for example) while the card user identification device 86 may select the matching verification code 106 using a second predefined manner (such as by skipping over a predefined number of the verification codes 106, for example). Furthermore, although selection of the comparison code 42 has been discussed above as occurring after reception of the verification code 106, the comparison code 42 may be selected any time after indication 158 is received by the verification entity device 14. For example, the comparison code 42 may be selected before the challenge code 38 is communicated for receipt by the card user identification device 86. As another example, the comparison code 42 may be selected after the challenge code 38 is communicated for receipt by the card user identification device 86, but before the verification entity device 14 receives the verification code 106.

Following receipt of the verification code 106 by the verification entity device 14 and further following selection of the comparison code 42 by the verification entity device 14, the verification entity device 14 may compare the verification code 106 to the comparison code 42 in order to determine whether the verification code 106 matches the comparison code 42. If the verification code 106 does not match the comparison code 42 (or a verification code 106 is never received in response to a challenge code 38), verification entity device 14 may deny the telephone transaction. This denial may result in a denial message (not shown) being sent to merchant verification device 54, merchant telephone device 74, card user telephone device 82, and/or card user identification device 86. As a result, the telephone transaction will not be allowed to occur. On the other hand, if the verification code 106 does match the comparison code 42, verification entity device 14 may verify the telephone transaction (or otherwise approve the processing of the telephone transaction) by communicating a verification signal 194 to merchant verification device 54 (and/or one or more of merchant telephone device 74, card user telephone device 82, and card user identification device 86). As such, the telephone transaction may be allowed to occur.

The verification signal 194 may allow the transaction to occur in any suitable manner. For example, the verification signal 194 may provide a signal to the merchant (such as a flashing green light on the merchant verification device 54) that indicates that the merchant may now process the payment card using the payment device (such as a cash register). In such an example, the merchant may now enter the payment card information into the payment device (or any other device that may cause the transaction to be processed). As another example, the payment card information may already be in the middle of being processed (as a result of the payment card information having been entered into merchant verification device 54), and the verification signal 194 may cause (automatically or by signaling the merchant to finalize the transaction by, for example, pushing a button) the processing of the payment card information to be completed. In such an example, the merchant may not need to enter the payment card information into the payment device (or any other device) again.

Although verification entity device 14 has been illustrated as comparing a single verification code 106 to a single comparison code 42 in order to verify a particular telephone transaction, in particular embodiments, verification entity device 14 may compare more than one verification code 106 to more than one comparison code 42 in order to verify the particular telephone transaction. For example, for each telephone transaction, two or more verification codes 106 and two or more comparison codes 42 may be selected for the verification process. In such an example, verification entity device 14 may only verify (or otherwise allow) the telephone transaction if each of the selected verification codes 106 match each of the selected comparison codes 42.

Furthermore, although verification entity device 14 has been illustrated as verifying (or otherwise approving) the telephone transaction if the verification code 106 matches the comparison code 42, in particular embodiments, verification (or approval) of the telephone transaction may include various additional steps. For example, verification entity device 14 may determine whether the payment card has been reported lost or stolen, whether the telephone transaction appears suspicious based on the card user's typical purchases, whether there is a sufficient balance associated with the payment card to approve the telephone transaction, whether the online transaction will cause a credit limit associated with the payment card (or account 34) to be overdrawn, whether a billing address listed in the payment card information received from the card user matches the billing address listed in account 34 for the card user, any other suitable method for determining whether to verify (or approve) the telephone transaction, or any combination of the preceding.

Additionally, although verification entity device 14 has been illustrated as storing and communicating challenge codes 38, storing and selecting comparison codes 42, and verifying the telephone transactions by comparing comparison codes 42 to verification codes 106, in particular embodiments, one or more (or all) of these actions may be performed by other devices or components of system 10, such as merchant verification device 54 and/or one or more third party devices or components. For example, merchant verification device 54 may store and communicate challenge codes 38, store and select comparison codes 42, and verify the telephone transactions by comparing comparison codes 42 to verification codes 106. In such an example, verification entity device 14 may approve the telephone transaction (or otherwise allow the telephone transaction to occur) if the merchant verification device 54 verifies the telephone transaction and communicates a verification signal (such as verification signal 194) to the verification entity device 14.

In particular embodiments, the above-described method of verifying a telephone transaction may provide additional protection against fraud. For example, even if a person (or a device) is able to steal or copy a card user's payment card information (such as the payment card number, expiration date, and verification code) or the payment card (itself), the person may be unable to conduct one or more telephone transactions using the payment card information (or the payment card) because the person may not also have the card user identification device 86. As another example, even if a person (or a device) is also able to attempt to respond to a challenge code 38 using a fraudulent device, the code provided by the fraudulent device may not match the comparison code 42 utilized by the verification entity device 14 because the fraudulent device may not have access to verification codes 106 or the verification management application 46b that results in a verification code 106 being selected in a predefined manner.

Modifications, additions, or omissions may be made to system 10 without departing from the scope of the invention. For example, verification entity device 14 may verify any number of telephone transactions that are performed using any number of verification entity devices 14, networks 50, merchant verification devices 54, merchant telephone devices 74, networks 78, card user telephone devices 82, card user identification devices 86, card users, and/or merchants. Additionally, system 10 may include any number of verification entity devices 14, networks 50, merchant verification devices 54, merchant telephone devices 74, networks 78, card user telephone devices 82, and/or card user identification devices 86 (and/or any number of components, such as processors or memory units illustrated in the above described devices). Also, any suitable logic may perform the functions of system 10 and the components and/or devices within system 10.

Furthermore, one or more components of system 10 may be combined. Also, system 10 may include additional components. For example, as is discussed above, a payment processor (such as a payment processing system run by, for example, First Data Merchant Services Corporation) may be communicatively located in-between the merchant verification device 54 and the verification entity device 14. In such an example, all or a portion of one or more communications between merchant verification device 54 and verification entity device 14 may be communicated through (and/or modified by) the payment processor.

Furthermore, one or more of the communications (such as all of the communications) between one or more components of system 10 (such as verification entity devices 14, networks 50, merchant verification devices 54, merchant telephone devices 74, networks 78, card user telephone devices 82, and/or card user identification devices 86) may be encrypted (or otherwise secured in any suitable manner), providing protection against fraudulent attempts to access the information included in the communications. Additionally, one or more of the communications (such as all of the communications) between one or more components of system 10 (such as verification entity devices 14, networks 50, merchant verification devices 54, merchant telephone devices 74, networks 78, card user telephone devices 82, and/or card user identification devices 86) may further include one or more codes that may assist in identifying the communication as being sent by one of the devices or components of system 10. For example, the merchant verification device 54 may generate a random code, and insert the code into any communication with the card user identification device 86. Based on this random code, card user identification device 86 may be able to identify the communication as having been sent by the merchant verification device 54, and thus the card user identification device 86 may respond to the communication. In such an example, the card user identification device 86 may also generate a random code, and insert the code into any communication with the merchant verification device 54. Based on this random code, merchant verification device 54 may be able to identify the communication as having been sent by the card user identification device 86, and thus the merchant verification device 54 may re-communicate the communication for receipt by the verification entity device 14.

FIG. 2 illustrates an example selection 200 of verification codes 106 and comparison codes 42. Verification codes 106 are selected by the card user identification device 86 of FIG. 1, and comparison codes 42 are selected by the verification entity device 14 of FIG. 1, for example. Furthermore, following selection (and communication) of verification codes 106 and comparison codes 42, verification entity device 14 may compare verification codes 106 to comparison codes 42 in order to determine whether to allow a telephone transaction to occur, as is discussed above.

Verification codes 106 and comparison codes 42 may each be selected according to a predefined manner based on verification management applications 46. For example, verification codes 106 and comparison codes 42 may be selected by sequentially rotating through each of the verification codes 106 and comparison codes 42 (e.g., rotating from a first code to a second code), by skipping over a predefined number of the verification codes 106 and comparison codes 42 (e.g., skipping from the first code to the fifth code), by selecting a position of one of the verification codes 106 and comparison codes 42 (e.g., selecting the code positioned in column five, row ten), any other manner of selecting one of the verification codes 106 and one of the comparison codes 42 according to a predefined manner based on verification management applications 46, or any combination of the preceding.

As illustrated, verification codes 106 and comparison codes 42 may each be selected by sequentially rotating through each of the verification codes 106 and comparison codes 42. For example, the card user identification device 86 may store the following verification codes 106: Code A, Code B, Code C, Code D, . . . Code n. Furthermore, the verification entity device 14 may store the following comparison codes 42, each of which match a respective verification code 106: Code A, Code B, Code C, Code D, . . . Code n.

In one example of the operation of selection 200, when a card user attempts to perform a first potential telephone transaction using a payment card (such as when a card user attempts to purchase a shirt from merchant A), the predefined manner (based on verification management application 46b) may cause the card user identification device 86 to select Code A as the verification code 106 for communication to the verification entity device 14. Furthermore, the same predefined manner (based on verification management application 46a) may cause the verification entity device 14 to select the matching Code A as the comparison code 42. As such, the verification code 106 (i.e., Code A) will match comparison code 42 (i.e., Code A), and the first telephone transaction will be allowed to proceed.

For the second potential telephone transaction of the card user (such as when the card user attempts to purchase shoes from merchant B), the predefined manner (based on verification management application 46b) may cause the card user identification device 86 to sequentially rotate to and select Code B as the verification code 106 for communication to the verification entity device 14. That is, the sequential rotation may cause the card user identification device 86 to rotate to and select the next verification code 106 (i.e., Code B) in the sequence of verification codes 106. Furthermore, the same predefined manner (based on verification management application 46a) may cause the verification entity device 14 to sequentially rotate to and select the matching Code B as the comparison code 42. As such, the verification code 106 (i.e., Code B) will match the comparison code 42 (i.e., Code B), and the second telephone transaction will be allowed to proceed.

This sequential rotation through (and selection of) the verification codes 106 and comparison codes 42 may continue until Code n is selected for both the verification code 106 and the comparison code 42. After Code n is selected, the process of selecting verification codes 106 and comparison codes 42 may be reset (as is seen by resets 204a and 204b) back to Code A. Therefore, for the next potential telephone transaction of the card user (such as when the card user attempts to pay for a hair cut from merchant O), the predefined manner (based on verification management application 46b) may cause the card user identification device 86 to sequentially rotate to (via reset 204a) and re-select Code A as the verification code 106 for communication to the verification entity device 14. Furthermore, the same predefined manner (based on verification management application 46a) may cause the verification entity device 14 to sequentially rotate to (via reset 204b) and re-select the matching Code A as the comparison code 42. As such, the verification code 106 (i.e., Code A) will match the comparison code 42 (i.e., Code A), and the next telephone transaction will be allowed to proceed.

Based on the sequential rotation through verification codes 106 and comparison codes 42, the verification codes 106 and comparison codes 42 may be rotated through continuously. This may allow the same code to be re-used as the verification code 106 and comparison code 42 at a later date and/or time from the original use of the code. As such, the card user identification device 86 may not need to receive new verification codes 106 from verification entity device 14 (or some other device associated with the verification entity) when all of the verification codes 106 have already been used.

Modifications, additions, or omissions may be made to selection 200 without departing from the scope of the invention. For example, although selection 200 illustrates a sequential rotation for selecting verification codes 106 and comparison codes 42, any other manner of selecting one of the verification codes 106 and one of the comparison codes 42 may be utilized (such as a reverse sequential rotation where the rotation process rotates from Code B to Code A; skipping over a predefined number of the verification codes 106 and comparison codes 42; selecting a position of one of the verification codes 106 and comparison codes 42; or any combination of the preceding). Additionally, selection 200 may be performed using any number of verification codes 106 and comparison codes 42.

This specification has been written with reference to various non-limiting and non-exhaustive embodiments. However, it will be recognized by persons having ordinary skill in the art that various substitutions, modifications, or combinations of any of the disclosed embodiments (or portions thereof) may be made within the scope of this specification. Thus, it is contemplated and understood that this specification supports additional embodiments not expressly set forth in this specification. Such embodiments may be obtained, for example, by combining, modifying, or reorganizing any of the disclosed steps, components, elements, features, aspects, characteristics, limitations, and the like, of the various non-limiting and non-exhaustive embodiments described in this specification. In this manner, Applicant reserves the right to amend the claims during prosecution to add features as variously described in this specification, and such amendments comply with the requirements of 35 U.S.C. §§112(a) and 132(a).

1. A telephone transaction verification system, comprising:
one or more memory units configured to:
store one or more instructions; and
store a plurality of comparison codes; and
one or more processors coupled to the memory units and configured, upon executing the one or more instructions, to:
receive an indication that a card user is attempting to perform a telephone transaction using payment card information and a card user telephone device, wherein the card user telephone device is communicatively coupled to a merchant telephone device with which the card user is attempting to perform the telephone transaction;
following reception of the indication, transmit a challenge code configured to interrogate a card user identification device for a first verification code, wherein the challenge code is received by the card user telephone device and re-transmitted by the card user telephone device to the card user identification device;
following transmittal of the challenge code, receive the first verification code from the card user identification device, wherein the first verification code is selected, by the card user identification device, from a plurality of verification codes stored by the card user identification device, wherein the first verification code is selected, by the card user identification device, according to a predefined manner, wherein the first verification code is transmitted by the card user identification device to the card user telephone device and re-transmitted by the card user telephone device to the merchant telephone device;
select a first comparison code from the plurality of comparison codes according to the predefined manner;
compare the first comparison code to the first verification code from the card user identification device; and
following a determination that the first comparison code matches the first verification code, transmit a verification signal configured to indicate that the telephone transaction has been verified.

2. The telephone transaction verification system of claim 1, wherein:
in accordance with the predefined manner, the one or more processors are further configured to sequentially rotate through the plurality of comparison codes in order to select the first comparison code; and
in accordance with the predefined manner, the first verification code is selected, by the card user identification device, by sequentially rotating through the plurality of verification codes.

3. The telephone transaction verification system of claim 2, wherein:
in accordance with the predefined manner, the one or more processors are further configured to re-select the first comparison code for use in verifying a subsequent telephone transaction after each of the other comparison codes have been sequentially rotated to and selected; and
in accordance with the predefined manner, the first verification code is re-selected, by the card user identification device, for use in verifying the subsequent telephone transaction after each of the other verification codes have been sequentially rotated to and selected.

4. The telephone transaction verification system of claim 1, wherein:
the challenge code is received, from the one or more processors, by a merchant verification device and re-transmitted by the merchant verification device to the merchant telephone device;
the challenge code is received by the merchant telephone device and re-transmitted by the merchant telephone device to the card user telephone device;
the first verification code is received by the merchant telephone device and re-transmitted by the merchant telephone device to the merchant verification device; and
the first verification code is received by the merchant verification device and re-transmitted by the merchant verification device to the one or more processors.

5. The telephone transaction verification system of claim 1, wherein:
the challenge code is re-transmitted by the card user telephone device to the card user identification device in the form of a first audio signal; and
the first verification code is transmitted by the card user identification device to the card user telephone device in the form of a second audio signal.

6. The telephone transaction verification system of claim 1, wherein the card user telephone device is selected from one of the following:
a landline telephone;
a mobile telephone; or
a voice over internet protocol device.

7. The telephone transaction verification system of claim 1, wherein the one or more processors are included in a merchant verification device associated with a merchant.

8. A tangible computer readable medium comprising logic configured, when executed by one or more processors, to:
store a plurality of comparison codes;
receive an indication that a card user is attempting to perform a telephone transaction using payment card information and a card user telephone device, wherein the card user telephone device is communicatively coupled to a merchant telephone device with which the card user is attempting to perform the telephone transaction;
following reception of the indication, transmit a challenge code configured to interrogate a card user identification device for a first verification code, wherein the challenge code is received by the card user telephone device and re-transmitted by the card user telephone device to the card user identification device;
following transmittal of the challenge code, receive the first verification code from the card user identification device, wherein the first verification code is selected, by the card user identification device, from a plurality of verification codes stored by the card user identification device, wherein the first verification code is selected, by the card user identification device, according to a predefined manner, wherein the first verification code is transmitted by the card user identification device to the card user telephone device and re-transmitted by the card user telephone device to the merchant telephone device;
select a first comparison code from the plurality of comparison codes according to the predefined manner;
compare the first comparison code to the first verification code from the card user identification device; and
following a determination that the first comparison code matches the first verification code, transmit a verification signal configured to indicate that the telephone transaction has been verified.

9. The tangible computer readable medium of claim 8, wherein:
in accordance with the predefined manner, the logic is further configured to sequentially rotate through the plurality of comparison codes in order to select the first comparison code; and
in accordance with the predefined manner, the first verification code is selected, by the card user identification device, by sequentially rotating through the plurality of verification codes.

10. The tangible computer readable medium of claim 9, wherein:
in accordance with the predefined manner, the logic is further configured to re-select the first comparison code for use in verifying a subsequent telephone transaction after each of the other comparison codes have been sequentially rotated to and selected; and
in accordance with the predefined manner, the first verification code is re-selected, by the card user identification device, for use in verifying the subsequent telephone transaction after each of the other verification codes have been sequentially rotated to and selected.

11. The tangible computer readable medium of claim 8, wherein:
the challenge code is received, from the one or more processors, by a merchant verification device and re-transmitted by the merchant verification device to the merchant telephone device;
the challenge code is received by the merchant telephone device and re-transmitted by the merchant telephone device to the card user telephone device;
the first verification code is received by the merchant telephone device and re-transmitted by the merchant telephone device to the merchant verification device; and
the first verification code is received by the merchant verification device and re-transmitted by the merchant verification device to the one or more processors.

12. The tangible computer readable medium of claim 8, wherein:
the challenge code is re-transmitted by the card user telephone device to the card user identification device in the form of a first audio signal; and
the first verification code is transmitted by the card user identification device to the card user telephone device in the form of a second audio signal.

13. The tangible computer readable medium of claim 8, wherein the card user telephone device is selected from one of the following:
a landline telephone;
a mobile telephone; or
a voice over internet protocol device.

14. A method, comprising:
storing, by one or more processors, a plurality of comparison codes;
receiving, by the one or more processors, an indication that a card user is attempting to perform a telephone transaction using payment card information and a card user telephone device, wherein the card user telephone device is communicatively coupled to a merchant telephone device with which the card user is attempting to perform the telephone transaction;
following reception of the indication, transmitting, by the one or more processors, a challenge code configured to interrogate a card user identification device for a first verification code, wherein the challenge code is received by the card user telephone device and re-transmitted by the card user telephone device to the card user identification device;
following transmittal of the challenge code, receiving, by the one or more processors, the first verification code from the card user identification device, wherein the first verification code is selected, by the card user identification device, from a plurality of verification codes stored by the card user identification device, wherein the first verification code is selected, by the card user identification device, according to a predefined manner, wherein the first verification code is transmitted by the card user identification device to the card user telephone device and re-transmitted by the card user telephone device to the merchant telephone device;
selecting, by the one or more processors, a first comparison code from the plurality of comparison codes according to the predefined manner;
comparing, by the one or more processors, the first comparison code to the first verification code from the card user identification device; and
following a determination that the first comparison code matches the first verification code, transmitting, by the one or more processors, a verification signal configured to indicate that the telephone transaction has been verified.

15. The method of claim 14, wherein:
in accordance with the predefined manner, the first comparison code is selected, by the one or more processors, by sequentially rotating through the plurality of comparison codes; and
in accordance with the predefined manner, the first verification code is selected, by the card user identification device, by sequentially rotating through the plurality of verification codes.

16. The method of claim 15, further comprising, in accordance with the predefined manner, re-selecting, by the one or more processors, the first comparison code for use in verifying a subsequent telephone transaction after each of the other comparison codes have been sequentially rotated to and selected, wherein, in accordance with the predefined manner, the first verification code is re-selected, by the card user identification device, for use in verifying the subsequent telephone transaction after each of the other verification codes have been sequentially rotated to and selected.

17. The method of claim 14, wherein:
the challenge code is received, from the one or more processors, by a merchant verification device and re-transmitted by the merchant verification device to the merchant telephone device;
the challenge code is received by the merchant telephone device and re-transmitted by the merchant telephone device to the card user telephone device;
the first verification code is received by the merchant telephone device and re-transmitted by the merchant telephone device to the merchant verification device; and
the first verification code is received by the merchant verification device and re-transmitted by the merchant verification device to the one or more processors.

18. The method of claim 14, wherein:
the challenge code is re-transmitted by the card user telephone device to the card user identification device in the form of a first audio signal; and
the first verification code is transmitted by the card user identification device to the card user telephone device in the form of a second audio signal.

19. The method of claim 14, wherein the card user telephone device is selected from one of the following:
a landline telephone;
a mobile telephone; or
a voice over internet protocol device.

20. The method of claim 14, wherein the one or more processors are included in a merchant verification device associated with a merchant.
